(19) United States
(12) Patent Application Publication
(10) Pub. No.: US 2021/0181782 A1
(43) Pub. Date: Jun. 17, 2021

(54) Optical Signal Processing Device

(71) Applicant: Nippon Telegraph and Telephone Corporation, Tokyo (JP)

(72) Inventors: Shiori Konisho, Musashino-shi, Tokyo (JP); Toshikazu Hashimoto, Musashino-shi, Tokyo (JP); Mitsumasa Nakajima, Musashino-shi, Tokyo (JP)

(21) Appl. No.: 17/268,777

(22) PCT Filed: Aug. 14, 2019
(86) PCT No.: PCT/JP2019/031971

§ 371 Date: Feb. 16, 2021

(30) Foreign Application Priority Data
Aug. 22, 2018 (JP) 2018-155727

(51) Int. Cl. G06E 3/00; G02F 3/00

(52) U.S. Cl. CPC G06E 3/005; G02F 3/00; G06E 3/008

(57) ABSTRACT

Provided is an optical signal processing device capable of improving computing accuracy without increasing the number of nodes of a reservoir layer. An optical signal processing device for converting an input one-dimensional signal to an optical signal and performing signal processing includes an input unit configured to perform linear processing on the input one-dimensional signal to convert the one-dimensional signal to an optical signal, a reservoir unit connected to an output of the input unit and configured to perform linear processing and nonlinear processing on the optical signal, an output unit connected to an output of the reservoir unit and configured to convert the optical signal to an electrical signal, perform linear processing to output a one-dimensional output, and a determination unit configured to determine whether the one-dimensional output from the output unit is to be output or to be input as the one-dimensional signal to the input unit.

### TECHNICAL FIELD

The present invention relates to an optical signal processing device that can be applied to optical reservoir computing.

### BACKGROUND ART

In recent years, an environment has been constructed to acquire a large amount of data from various sensors via the Internet, and research and business for analyzing the large amount of acquired data and performing highly accurate knowledge processing and future prediction has been actively carried out. In general, because analysis of enormous data requires time and cost such as power consumption, a computing device having high speed and high efficiency is required. As a computing scheme for such information processing, an optical computing technique called reservoir computing (RC), which imitates signal processing of a cerebellum, has been proposed. Optical computing devices using a dynamical system are attracting attention because the devices are likely to have both high speed and high efficiency.

In an example of an application of optical RC in the related art, an example of solving a one-dimensional input and output problem such as a chaos approximation problem and NARMA10 has been mainly reported (for example, see Non Patent literature 1). Further, it is necessary to improve computing accuracy in order to further widen a range of applications of optical RC. In RC, it is generally known that the computing accuracy is improved by an increase in the number of nodes of a reservoir layer. However, in the case of optical RC, because the nodes of the reservoir layer are represented by the number of optical pulses that circulate around a fiber ring, a device having a longer fiber ring is required in order to increase the number of nodes and improve the computing accuracy.

### CITATION LIST

### Non Patent Literature

Non Patent Literature 1: L. Larger, et al., “Photonic information processing beyond Turing: an optoelectronic implementation of reservoir computing,” Optics Express Vol. 20, Issue 3, pp. 3241-3249 (2012)

### SUMMARY OF THE INVENTION

### Technical Problem

There are three problems when the fiber ring is lengthened. A first problem is an increase in manufacturing cost of a device. Because a price of a fiber is determined depending on the length, a cost of the fiber increases when the fiber ring is lengthened. A second problem is an increase in a size of the device. Because the fiber cannot be bent at an acute angle in view of loss, a volume for accommodation of the fiber increases when the fiber ring is lengthened. A third problem is unstable operation of the device. Because an optical pulse signal in the fiber easily changes due to an influence of a vibration or temperature change, an operating environment satisfying severe environmental conditions is required as the fiber ring is lengthened.

### Means for Solving the Problem

An object of the present invention is to provide an optical signal processing device capable of improving computing accuracy without increasing the number of nodes of a reservoir layer.

In order to achieve such an object, an aspect of the present invention is an optical signal processing device for converting an input one-dimensional signal to an optical signal and performing signal processing, the optical signal processing device including: an input unit configured to perform linear processing on the input one-dimensional signal to convert the one-dimensional signal to an optical signal; a reservoir unit connected to an output of the input unit and configured to perform linear processing and nonlinear processing on the optical signal; an output unit connected to an output of the reservoir unit and configured to convert the optical signal to an electrical signal, perform linear processing to output a one-dimensional output; and a determination unit configured to determine whether the one-dimensional output from the output unit is to be output or to be input as the one-dimensional signal to the input unit.

### Effects of the Invention

According to the present invention, a multi-layer structure in which a computing result calculated by optical RC is input to the input unit again is adopted by including the determination unit that is connected to the output unit and determines whether or not the output from the output unit is fed back as an input signal again, and it is possible to improve computing accuracy without increasing the number of nodes of a reservoir layer corresponding to one layer.

### BRIEF DESCRIPTION OF DRAWINGS

FIG. 1 is a diagram illustrating an overall configuration of an optical signal processing device according to an embodiment of the present invention.

FIG. 2 is a diagram illustrating a configuration of an input unit of the optical signal processing device according to the embodiment.

FIG. 3 is a diagram illustrating a configuration of a reservoir unit of the optical signal processing device according to the embodiment.

FIG. 4 is a diagram illustrating a specific operation example of the reservoir unit.

FIG. 5 is a diagram illustrating a configuration of an output unit of the optical signal processing device according to the embodiment.

### DESCRIPTION OF EMBODIMENTS

Hereinafter, embodiments of the present invention will be described in detail with reference to the drawings.

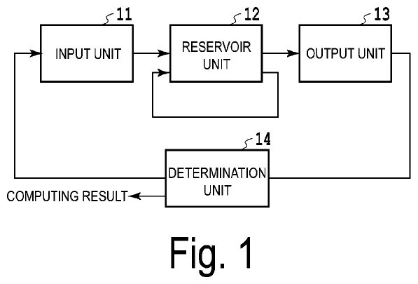

FIG. 1 illustrates an overall configuration of an optical signal processing device according to an embodiment of the present invention. The optical signal processing device includes an input unit 11 that performs linear processing on an input one-dimensional signal to convert the signal into an optical signal, a reservoir unit 12 that is connected to an output of the input unit 11 and performs random linear processing and nonlinear processing on the optical signal, and an output unit 13 that is connected to an output of the reservoir unit 12, converts an optical signal into an electrical signal to perform linear processing to output a one-dimensional output. Further, the optical signal processing device includes a determination unit 14 that determines whether the one-dimensional output from the output unit 13 is output or the output is input as the one-dimensional signal to the input unit.

The optical signal processing device according to the embodiment adopts a multi-layer structure in which a computing result calculated by optical RC is input to the reservoir unit 12 again by including the determination unit 14 that determines whether or not the output from the output unit 13 is fed back as an input signal again, and it is possible to effectively increase the number of nodes and improve computing accuracy. In other words, it is possible to improve the computing accuracy without increasing the number of nodes in each reservoir unit using a device configuration in which the numbers of nodes of the reservoir units 12 are the same.

Input Unit

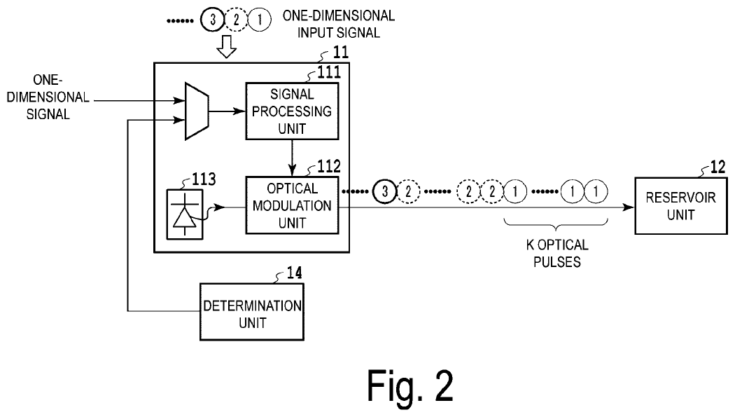

FIG. 2 illustrates a configuration of the input unit of the optical signal processing device according to the embodiment. The input unit 11 has a function of receiving the one-dimensional signal of a problem to be solved, converting the one-dimensional signal to a predetermined optical signal (an optical pulse train), and propagating the optical signal to the reservoir unit 12. The one-dimensional input signal to be input to a signal processing unit 111 differs depending on the number of layers of optical RC. A round of an input layer, a reservoir layer, and an output layer, which is a configuration of normal RC, is counted as one layer. Assuming deep optical RC of C layers, the one-dimensional signal of the problem to be solved by the optical RC is input to the input unit 11 in a first layer. In an A-th (1<A≤C) layer, the one-dimensional signal is first input to the deep optical RC, and then the one-dimensional time-series signal propagating from the determination unit 14 is input to an (A−1)-th layer.

A case in which the input signal is distributed from one input channel to m nodes of the reservoir layer in normal RC is considered. Here, the input channel corresponds to a sampling number (voice data or the like) or the number of pixels (image data or the like) of one piece of data (which is represented as a pulse train in which one pulse is arranged in FIG. 2). The signal processing unit 111 generates a time-series signal obtained by extending the one-dimensional input signal K-fold in a time axis direction for each pulse. For example, when a pulse width of one input channel is one second, a pulse having a pulse width of K seconds is generated. A subscript K is 1≤K≤m, and is intended to cause K nodes to be selected from among m nodes of normal RC and cause a one-dimensional input signal to be input.

A randomly determined weight wⁱⁿₗₘ of the input unit is then multiplied with the extended time-series signal. A subscript 1 is a type of the one-dimensional signal in the first layer corresponding to the input channel, and is N in the second and subsequent layers. This allows a pulse extended to K seconds to be a modulation signal having different intensity for one second. An optical modulation unit 112 modulates an optical signal from a light source 113 with a modulation signal having information of wⁱⁿₗₘ·um.

Thus, the input unit 11 outputs, to the reservoir unit 12, a pulse train in which K pulses having light intensity corresponding to a magnitude (intensity) of the input signal are connected by the number of 1 types of one-dimensional signals for each time step uₘ.

For the light source 113, an incoherent light source or a coherent light source can be used. When the former is used, the light source can be operated relatively stably because only intensity information is used. When the latter is used, an amount of information can be doubled because both intensity information and phase information are used.

For the optical modulation unit 112, an optical attenuator such as an LN modulator or an optical amplifier such as a semiconductor optical amplifier can be used. When the former is used, it is possible to shorten a computing time because modulation can be performed at a high speed. When the latter is used, it is possible to curb deterioration of computing capability due to a loss because a signal can be amplified.

A weight wⁱⁿ of the input unit is given before training of optical RC starts, and a value of the weight is not updated through training or a determination. All values of respective elements of the weight wⁱⁿ (weight wⁱⁿ≥0) may be different values, or may be the same value for the same m. Although the number of weights differs between the first layer and the second layer, the weights may be different or some of the weights may be the same.

Specific Operation Example

The one-dimensional signal is one-dimensional time-series data, such as a transition in a stock price of a certain company or a transition in temperature at a certain weather station. A case of utilization for temperature prediction in a specific weather station will be described herein.

Time-series data of temperature during a predetermined period of time is divided by certain periods of time, and data is created for each of the divided periods. For example, the predetermined period of time is divided into nine (1=9), and an average temperature during the divided period of time is calculated and used as the one-dimensional input signal. The signal processing unit 111 generates a time-series signal obtained by extending the one-dimensional input signal K-fold in order to perform processing m times in the reservoir unit 12, and multiplies the weight wⁱⁿ of the input unit with the time-series signal to generate a modulation signal. The weight wⁱⁿ may be a random value among K values.

The optical modulation unit 112 modulates the optical signal from the light source 113 with a modulation signal, outputs K optical pulses having different light intensities from one input signal, and combines all of the divided one-dimensional signals to output 9 K optical pulse trains.

Reservoir Unit

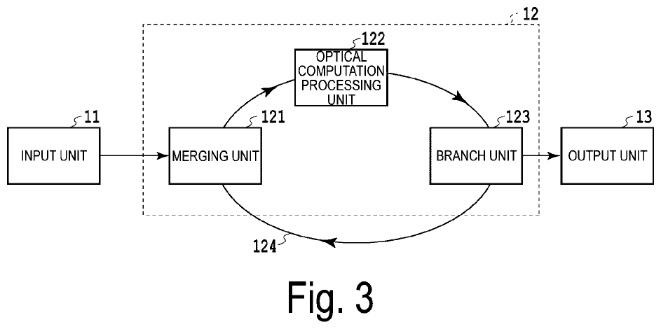

FIG. 3 illustrates a configuration of the reservoir unit of the optical signal processing device according to the embodiment. In the reservoir unit 12, a merging unit 121, an optical computation processing unit 122, and a branch unit 123 are provided on a ring waveguide 124 around which an optical pulse train circulates. Going from the merging unit 121 to the ring waveguide 124 and back to the merging unit 121 is counted as one round. After a first pulse train is input to the ring waveguide 124, a one-dimensional input signal propagating from the input unit 11 at a t-th round and a one-dimensional input signal circulating around the ring waveguide 124 and returning to the merging unit 121 at a (t−1)-th round are combined by the merging unit 121. The optical computation processing unit 122 performs computation processing on the combined one-dimensional input signal, and the branch unit 123 causes the processed one-dimensional input signal (optical pulse train) to branch to output the branching one-dimensional input signal to the output unit 13 and the merging unit 121.

A dynamic system in the reservoir unit 12 is shown in Equation (1).

Math. 1

x₁(t)=cos²(Σₘ^{K}wₗₘⁱⁿ·uₘ(t)+Σₖ^{K}w_{Ik}^{r}·xₖ(t−1)) (1)

Here, uₘ is a time step of the input unit 11 and corresponds to a node of the input layer, wⁱⁿₗₘ represents a weight of the input unit, xₖ(t−1) corresponds to a node of the reservoir layer when a pulse circulates around the waveguide 124 t−1 times, w^{r}ᵢₖ represents a weight of the reservoir unit, and x₁ corresponds to m nodes of the reservoir layer. Among components input to a cos square function of Equation (1), a first term indicates a signal coupled from the input unit 11, and a second term indicates a signal coupled from the reservoir unit 12. A weight w^{r} of the reservoir unit is a fixed value that is randomly determined, like the weight of the input unit. The optical computation processing unit 122 performs linear processing for multiplying the weight w^{r} of the reservoir unit and nonlinear processing for performing computation of a nonlinear function (a cos square function). The weight w^{r} of the reservoir unit is a fixed value that is randomly determined, as in the input unit.

For the optical computation processing unit 122, methods of performing linear processing include a method of using an LN modulator and a delay circuit, and a method of demodulating a signal with an electrical signal once, performing electrical computation processing using a PC, an FPGA, or the like, and then performing return to an optical signal. When the former is used, a processing speed becomes higher because the calculation is performed at the speed of light. When the latter is used, it is possible to ensure the computing accuracy because signal compensation can be performed when conversion to electricity is performed.

The optical computation processing unit 122 can use, for example, a Mach-Zehnder interferometer or a semiconductor optical amplifier in order to perform the nonlinear processing. When the former is used, power consumption is reduced because nonlinear processing is performed with only passage through the Mach-Zehnder interferometer without using a control signal. When the latter is used, it is possible to change a form of the nonlinear function from the cos square function by changing a current value injected into the semiconductor optical amplifier, and to perform adjustment to an appropriate nonlinear function for a problem to be solved.

For the merging unit 123, for example, a planar optical waveguide (PLC) or a fusion-extended fiber coupler can be used. When the former is used, it is possible to reduce a connection loss and construct a device with a low loss. When the latter is used, it is possible to easily construct the device by combining commercially available products.

Specific Operation Example

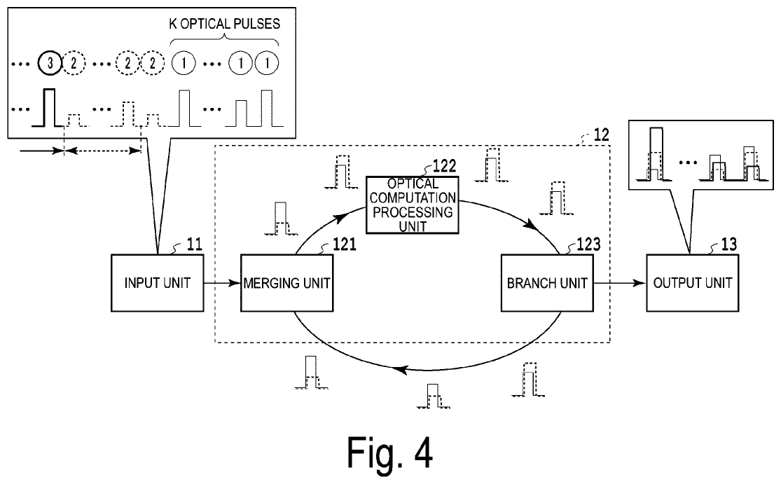

A specific operation example of the reservoir unit will be described with reference to FIG. 4. The ring waveguide 124 of the reservoir unit 12 is set to have a length in which K pulses circulate once at equal intervals. When pulse trains are input sequentially from K pulse trains of a first type from the input unit 11, the pulse trains sequentially circulate around the ring waveguide 124, and when K pulses of a 9-th type are input, all nine types of pulses are caused to overlap, as illustrated in FIG. 4. In the optical computation processing unit 122, the linear processing for multiplying the weight w^{r} of the reservoir unit and the nonlinear processing for passing a cos square function are performed for each circulation of the pulse, and adjustment of light intensity of the pulse that is an appropriate fixed value is performed. K pulses, each including nine overlapping pulses, are output from the branch unit 123 to the output unit 13.

The ring waveguide 124 may be extended in length so that K or more pulses can circulate at the same time in consideration of extensibility. In this case, in the pulse train output from the input unit 11, an idle period of time corresponding to a time corresponding to the extended length is inserted into every K pulses. Thus, the temperature data divided in nine is processed by the m nodes of the reservoir layer.

Output Unit

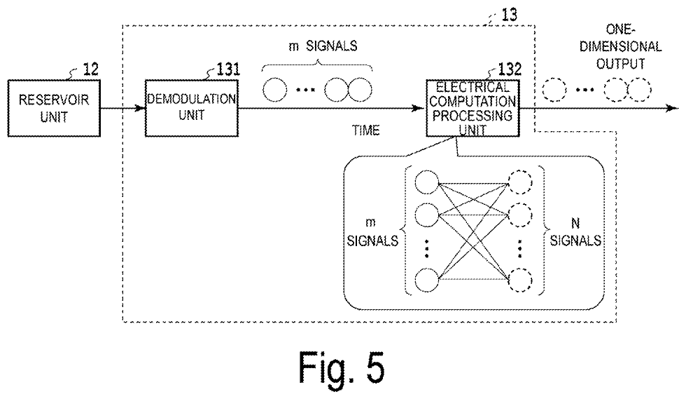

FIG. 5 illustrates a configuration of the output unit of the optical signal processing device according to the embodiment. The output unit 13 processes the optical pulse train emitted from the reservoir unit 12 to generate a one-dimensional output. The output unit 13 includes a demodulation unit 131 that converts the optical pulse train emitted from the reservoir unit 12 to an electrical signal, and an electrical computation processing unit 132 that extracts m one-dimensional signals at a time from the converted electrical signal and performs linear processing of m input N output.

A dynamic system in the output unit 13 is shown in Equation (2).

Math. 2

yⱼ(t)=ₖ^{m}wⱼₖ^{o}·xₖ(t) (2)

Here, yⱼ corresponds to a node of the output layer, and w^{o}ⱼₖ is a weight of the output unit. The electrical computation processing unit 132 extracts m of the one-dimensional signals xₖ(t) output from the demodulation unit at a time and calculates the linear combination shown in Equation (2). The calculation is repeated a number of times corresponding to the number N of categories to be classified, and N one-dimensional outputs are generated from m signals. A weight w^{o} of the output unit is a value that is calculated by a pseudo-inverse matrix method using a node xₖ(t) of the reservoir unit and a desired result of the problem to be solved. This value is different for each layer.

For the demodulation unit 131, a light receiver is used. For the electrical computation processing unit 132, a PC and an FPGA, for example, can be used. When the former is used, it is possible to implement a dynamical system relatively easily. When the latter is used, it is possible to increase a computing speed because dedicated machine can be manufactured.

Specific Operation Example

In the reservoir unit 12, the temperature data divided in nine is processed by the m nodes of the reservoir layer. In the output unit 13, N candidate values for a transition in the predicted temperature are obtained from K pieces of data processed in the reservoir layer.

Determination Unit

The determination unit 14 determines whether the one-dimensional signal output from the output unit 13 is to be read as a computing result or to be propagated as an input signal to the input unit 11 again. For example, when data having a length of Lᵢₙₚᵤₜ seconds of the one-dimensional signal input to the input unit 11 is solved by RC of A layers, data up to Lᵢₙₚᵤₜ×(A−1) seconds after the signal first propagates to the determination unit 14 propagates to the input unit 11, and data after Lᵢₙₚᵤₜ×(A−1) seconds is read as a computing result.

For the determination unit 14, a switch can be used. An operation timing of the switch is synchronized with a device that generates the modulation signal of the input unit 11.

Specific Operation Example

As described above, in the first layer, the one-dimensional signal of the problem to be solved by the optical RC is input to the input unit 11, and in the A-th (1<A≤C) layer, the one-dimensional signal is first input to the deep optical RC and then the one-dimensional time-series signal propagating from the determination unit 14 is input at an (A−1)-th round. That is, the determination unit 14 causes the output from the output unit 13 to be input as a one-dimensional signal to the input unit 11 again when the number of times the output unit 13 performs output is smaller than A, and causes the output from the output unit 13 to be output as a one-dimensional output when the number of times the output unit 13 performs output is A. Thus, deep optical RC of the C layers is executed, and the most probable candidate value of the temperature is obtained in the temperature prediction.

With the optical signal processing device of the embodiment, it is possible to improve the computing accuracy using a device configuration in which the numbers of nodes are the same by adopting a multi-layer structure in which the computing result calculated by optical RC is input to optical RC again, instead of increasing the number of nodes. In optical RC in the related art, the number of nodes of the reservoir layer is increased so that the computing accuracy is improved, whereas in the embodiment, it is possible to improve the computing accuracy with the same number of nodes, it is not necessary to lengthen the fiber ring in the reservoir layer, and it is possible to curb a manufacturing cost of the device and reduce a size of the device. Further, in the embodiment, it is possible to stabilize an operation of the device because the computation can be performed with a short fiber ring.

### REFERENCE SIGNS LIST

11 Input unit
12 Reservoir unit
13 Output unit
14 Determination unit
111 Signal processing unit
112 Optical modulation unit
113 Light source
121 Merging unit
122 Optical computation processing unit
123 Branch unit
124 Ring waveguide
131 Demodulation unit
132 Electrical computation processing unit

1. An optical signal processing device for converting an input one-dimensional signal to an optical signal and performing signal processing, the optical signal processing device comprising:
an input unit configured to perform linear processing on the input one-dimensional signal to convert the one-dimensional signal to an optical signal;
a reservoir unit connected to an output of the input unit and configured to perform linear processing and nonlinear processing on the optical signal;
an output unit connected to an output of the reservoir unit and configured to convert the optical signal to an electrical signal, perform linear processing to output a one-dimensional output; and
a determination unit configured to determine whether the one-dimensional output from the output unit is to be output or to be input as the one-dimensional signal to the input unit.

2. The optical signal processing device according to claim 1, wherein the input unit includes:
a light source;
a signal processing unit configured to extend, as a one-dimensional signal, the input one-dimensional signal in a first layer and the one-dimensional output from the determination unit in an A-th (1<A) layer in a time axis direction, and perform linear processing to generate a modulation signal; and
an optical modulation unit connected to the light source and configured to generate an optical pulse train using the modulation signal.

3. The optical signal processing device according to claim 2, wherein the reservoir unit includes:
a merging unit configured to input the optical pulse train from the input unit to a ring waveguide;
an optical computation processing unit configured to perform linear processing and nonlinear processing on the optical pulse train that circulates around the ring waveguide; and
a branch unit configured to cause the optical pulse train processed in the optical computation processing unit to branch to output the branching optical pulse train to the output unit and the merging unit.

4. The optical signal processing device according to claim 3, wherein the output unit includes:
a demodulation unit configured to convert the optical pulse train processed in the reservoir unit to an electrical signal; and
an electrical computation processing unit configured to extract a one-dimensional signal from the electrical signal, perform linear processing, and output a one-dimensional output.

5. An optical signal processing device that converts an input one-dimensional signal to an optical signal, performs signal processing, performs a multi-layer (C layers) computing processing, and outputs a one-dimensional output, the optical signal processing device comprising:
an input unit configured to generate a time-series signal obtained by extending, as a one-dimensional signal, the input one-dimensional signal in a first layer and the one-dimensional output in an A-th (1<A≤C) layer K (1≤K≤m)-fold in a time axis direction, multiply a predetermined weight with the time-series signal to convert the one-dimensional signal to K optical pulse trains;
a reservoir unit configured to cause the optical pulse train from the input unit to circulate around a ring waveguide so that the optical pulse trains overlap, multiply a predetermined weight with the overlapped optical pulse train, and perform computation of a nonlinear function;
an output unit configured to convert the optical pulse train processed in the reservoir unit to an electrical signal, extract m one-dimensional signals from the converted electrical signal at a time, and multiply a predetermined weight with the one-dimensional signal to generate N one-dimensional outputs; and
a determination unit configured to cause the output from the output unit to be input to the input unit as a one-dimensional signal again when the number of times the output unit performs output is smaller than A, and cause the output from the output unit to be output as a one-dimensional output when the number of times the output unit performs output is A,
wherein the optical signal processing device performs computation processing of A (1<A≤C) layers.
